(19) United States
(12) Patent Application Publication
(10) Pub. No.: US 2025/0333566 A1
(43) Pub. Date: Oct. 30, 2025

(54) METHOD FOR PRODUCING FLUOROPOLYETHER GROUP-CONTAINING CARBOXYLIC ACID

(71) Applicant: DAIKIN INDUSTRIES, LTD., Osaka (JP)

(72) Inventors: Yuka KAWAKAMI, Osaka (JP); Yusuke WATANABE, Osaka (JP); Hisashi MITSUHASHI, Osaka (JP); Takashi YASUHARA, Osaka (JP); Hiroshi MOMOTA, Osaka (JP); Kenichi KATSUKAWA, Osaka (JP)

(73) Assignee: DAIKIN INDUSTRIES, LTD., Osaka (JP)

(21) Appl. No.: 19/260,784

(22) Filed: Jul. 7, 2025

Related U.S. Application Data
(63) Continuation of application No. PCT/JP2024/000067, filed on Jan. 5, 2024.

(30) Foreign Application Priority Data
Jan. 6, 2023 (JP) 2023-001197

(51) Int. Cl. C08G 65/00

(52) U.S. Cl. CPC C08G 65/007

(57) ABSTRACT

A method for producing a fluoropolyether group-containing carboxylic acid from a fluoropolyether group-containing carboxylic acid ester, comprising using propionic acid.

### CROSS REFERENCE TO RELATED APPLICATIONS

This application is a Rule 53(b) Continuation Application of International Application No. PCT/JP2024/000067, filed on Jan. 5, 2024, which claims priority to Japanese Patent Application No. 2023-001197, filed on Jan. 6, 2023, the disclosures of which are incorporated by reference herein their entireties.

### TECHNICAL FIELD

The present disclosure relates to a method for producing a fluoropolyether group-containing carboxylic acid.

### BACKGROUND ART

Referring to the method for producing a fluoropolyether group-containing carboxylic acid, the fluoropolyether group-containing carboxylic acid is known to be produced from a fluoropolyether group-containing carboxylic acid ester. For example, Patent Literature 1 discloses that a fluoropolyether group-containing carboxylic acid can be obtained by hydrolyzing a fluoropolyether group-containing carboxylic acid ester in the presence of an aqueous solution containing an alkali metal hydroxide.

### PRIOR ART LITERATURE

### Patent Literature

Patent Literature 1: WO 2019/163712

### SUMMARY

The present disclosure includes the following embodiment.

[1] A method for producing a fluoropolyether group-containing carboxylic acid from a fluoropolyether group-containing carboxylic acid ester, using propionic acid.

### DESCRIPTION OF EMBODIMENTS

The present disclosure provides a method for producing a fluoropolyether group-containing carboxylic acid from a fluoropolyether group-containing carboxylic acid ester, comprising using propionic acid.

### Fluoropolyether Group-Containing Carboxylic Acid Ester

The fluoropolyether group-containing carboxylic acid ester refers to a compound including a fluoropolyether group and a carboxylic acid ester group.

In a preferred embodiment, the fluoropolyether group-containing carboxylic acid ester is a compound represented by the following formula (1) or (2):

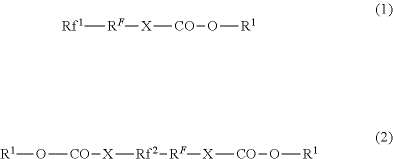

wherein Rf¹ is each independently at each occurrence a C₁₋₁₆ alkyl group optionally substituted with one or more fluorine atoms,
Rf² is a C₁₋₆ alkylene group optionally substituted with one or more fluorine atoms,
R^{F} is each independently at each occurrence a divalent fluoropolyether group,
X is a single bond or a divalent organic group, and
R¹ is a C₁₋₆ alkyl group.

The fluoropolyether group-containing carboxylic acids obtained from the fluoropolyether group-containing carboxylic acid ester represented by the formulas (1) and (2) are each represented by the following formulas (3) and (4).

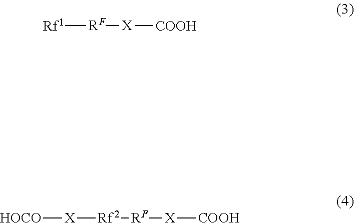

In one embodiment, the fluoropolyether group-containing carboxylic acid ester is a compound represented by the formula (1).

In another embodiment, the fluoropolyether group-containing carboxylic acid ester is a compound represented by the formula (2).

In another embodiment, the fluoropolyether group-containing carboxylic acid ester includes both the compound represented by the formula (1) and the compound represented by the formula (2).

In the formula, Rf¹ is each independently at each occurrence a C₁₋₁₆ alkyl group optionally substituted with one or more fluorine atoms.

The “C₁₋₁₆ alkyl group” in the C₁₋₁₆ alkyl group optionally substituted with one or more fluorine atoms may be linear or branched, and is preferably a linear or branched C₁₋₆ alkyl group, particularly C₁₋₃ alkyl group, more preferably a linear C₁₋₆ alkyl group, particularly C₁₋₃ alkyl group.
Rf¹ is preferably a C₁₋₁₆ alkyl group substituted with one or more fluorine atoms, more preferably a CF₂H—C₁₋₁₅ perfluoroalkylene group, still more preferably a C₁₋₁₆ perfluoroalkyl group.

The C₁₋₁₆ perfluoroalkyl group may be linear or branched, and is preferably a linear or branched C₁₋₆ perfluoroalkyl group, particularly C₁₋₃ perfluoroalkyl group, more preferably a linear C₁₋₆ perfluoroalkyl group, particularly C₁₋₃ perfluoroalkyl group, specifically —CF₃, —CF₂CF₃, or —CF₂CF₂CF₃.

In the formula, Rf² is a C₁₋₆ alkylene group optionally substituted with one or more fluorine atoms.

The “C₁₋₆ alkylene group” in the C₁₋₆ alkylene group optionally substituted with one or more fluorine atoms may be linear or branched, and is preferably a linear or branched C₁₋₃ alkylene group, and more preferably a linear C₁₋₃ alkylene group.

Rf² is preferably a C₁₋₆ alkylene group substituted with one or more fluorine atoms, more preferably a C₁₋₆ perfluoroalkylene group, still more preferably a C₁₋₃ perfluoroalkylene group.

The C₁₋₆ perfluoroalkylene group may be linear or branched, and is preferably a linear or branched C₁₋₃ perfluoroalkylene group, more preferably a linear C₁₋₃ perfluoroalkylene group, specifically —CF₂—, —CF₂CF₂—, or —CF₂CF₂CF₂—.

In the formula, R^{F} is each independently at each occurrence, a divalent fluoropolyether group.

R^{F} may preferably include a group represented by the following:

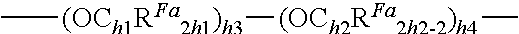

wherein R^{Fa} is each independently at each occurrence a hydrogen atom, a fluorine atom or a chlorine atom,
h1 is an integer of 1 to 6,
h2 is an integer of 4 to 8,
h3 is an integer of 0 or more,
h4 is an integer of 0 or more,
provided that the sum of h3 and h4 is 1 or more, preferably 2 or more, more preferably 5 or more, and the occurrence order of the respective repeating units in parentheses provided with h3 and h4 is not limited in the formula.

In one embodiment, R^{F} may be linear or branched. R^{F} is preferably a group represented by the formula:

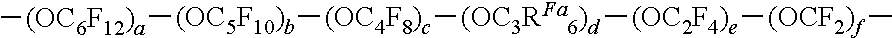

wherein R^{Fa} is each independently at each occurrence a hydrogen atom, a fluorine atom or a chlorine atom,
a, b, c, d, e, and f are each independently an integer of 0 to 200, the sum of a, b, c, d, e, and f is 1 or more, the occurrence order of the respective repeating units in parentheses provided with a, b, c, d, e, or f is not limited in the formula, provided that if all R^{Fa}s are a hydrogen atom or a chlorine atom, at least one of a, b, c, e, and f is 1 or more.
R^{Fa} is preferably a hydrogen atom or a fluorine atom, and more preferably a fluorine atom. If all R^{Fa}s are a hydrogen atom or a chlorine atom, at least one of a, b, c, e, and f is 1 or more.
a, b, c, d, e, and f may be each independently an integer of preferably 0 to 100, more preferably 0 to 60, and for example, 1 to 100, 5 to 100, 10 to 100, 20 to 100, 25 to 100, 1 to 60, 5 to 60, 10 to 60, 20 to 60, 25 to 60, 1 to 50, 5 to 50, 10 to 50, 20 to 50, 25 to 50, 1 to 40, 5 to 40, 10 to 40, 20 to 40, or 25 to 40.

The sum of a, b, c, d, e, and f is preferably 5 or more, more preferably 10 or more, and for example, may be 15 or more, or 20 or more. The sum of a, b, c, d, e, and f is preferably 200 or less, more preferably 100 or less, further preferably 60 or less, and for example, may be 50 or less or 30 or less. The sum of a, b, c, d, e, and f may be, for example, 15 to 100, 20 to 100, 15 to 60, 20 to 60, 15 to 50, or 20 to 50.

These repeating units may be linear or branched. For example, —(OC₆F₁₂— may be —(OCF₂CF₂CF₂CF₂CF₂CF₂)—, —(OCF(CF₃CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, or —(OCF₂CF₂CF₂CF₂CF(CF₃))—. —(OC₅F₁₀)— may be —(OCF₂CF₂CF₂CF₂CF₂)—, —(OCF(CF₃)CF₂CF₂CF₂)—, —(OCF₂CF(CF₃)CF₂CF₂)—, —(OCF₂CF₂CF(CF₃)CF₂)—, or —(OCF₂CF₂CF₂CF(CF₃))—. —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)—, and —(OCF₂CF(C₂F₅))—. —(OC₃F₆)— (i.e. in the formula, R^{Fa} is a fluorine atom) may be any of —(OCF₂CF₂CF₂)—, —(OCF(CF₃)CF₂)—, and —(OCF₂CF(CF₃))—. —(OC₂F₄)— may be any of —(OCF₂CF₂)— and —(OCF(CF₃))—.

In one embodiment, the above repeating unit is linear.

In one embodiment, the above repeating unit is branched.

In one embodiment, R^{F} may include a ring structure.

The ring structure may be the following 3-membered ring, 4-membered ring, 5-membered ring or 6-membered ring.

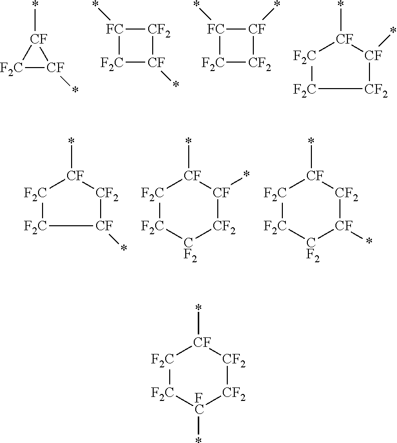

wherein * represents a binding position.

The ring structure may be preferably a 4-membered ring, a 5-membered ring or a 6-membered ring, and more preferably a 4-membered ring or a 6-membered ring.

The repeating unit having a ring structure may be preferably the following unit.

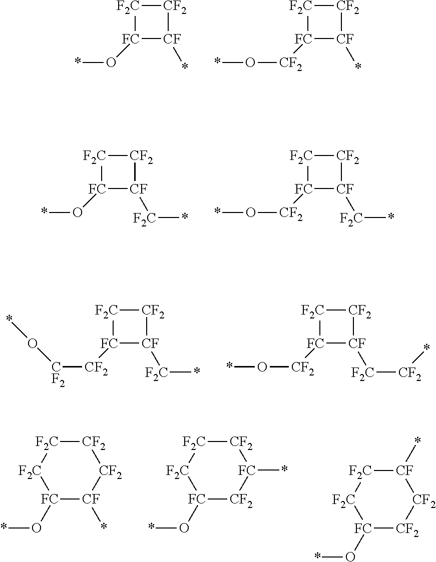

wherein * represents a binding position.

In one embodiment, R^{F} is each independently at each occurrence a group represented by any of the following formulas (f1) to (f6):

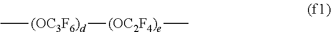

wherein d is an integer of 1 to 200 and e is 0 or 1;

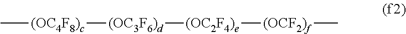

wherein c and d are each independently an integer of 0 or more and 30 or less, e and f are each independently an integer of 1 or more and 200 or less,
the sum of c, d, e, and f is 2 or more, and
the occurrence order of the respective repeating units in parentheses provided with subscript c, d, e, or f is not limited in the formula;

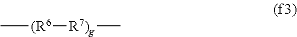

wherein R⁶ is OCF₂ or OC₂F₄,
R⁷ is a group selected from OC₂F₄, OC₃F₆, OC₄F₈, OC₅F₁₀ and OC₆F₁₂ or a combination of two or three groups independently selected from these groups, and
g is an integer of 2 to 100;

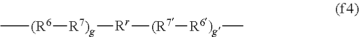

wherein R⁶ is OCF₂ or OC₂F₄,
R⁷ is a group selected from OC₂F₄, OC₃F₆, OC₄F₈, OC₅F₁₀ and OC₆F₁₂ or a combination of two or three groups independently selected from these groups,
R⁶′ is OCF₂ or OC₂F₄,
R⁷′ is a group selected from OC₂F₄, OC₃F₆, OC₄F₈, OC₅F₁₀ and OC₆F₁₂ or a combination of two or three groups independently selected from these groups,
g is an integer of 2 to 100,
g′ is an integer of 2 to 100, and
R^{r} is

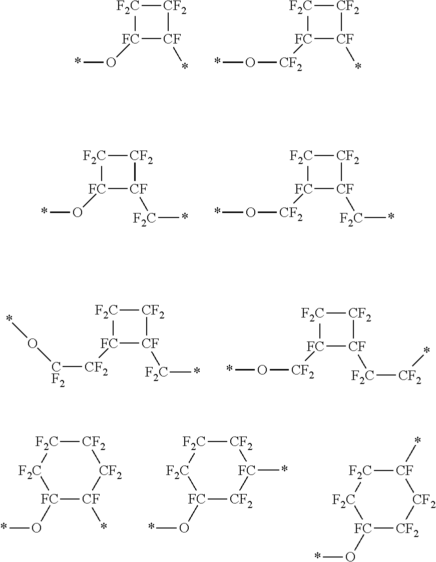

wherein * represents a binding position;

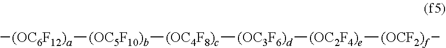

wherein e is an integer of 1 or more and 200 or less, a, b, c, d, and f are each independently an integer of 0 or more and 200 or less, and the occurrence order of the respective repeating units in parentheses provided with a, b, c, d, e, or f is not limited in the formula,

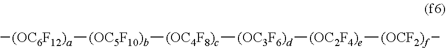

wherein f is an integer of 1 or more and 200 or less, a, b, c, d, and e are each independently an integer of 0 or more and 200 or less, and the occurrence order of the respective repeating units in parentheses provided with a, b, c, d, e, or f is not limited in the formula.

In the formula (f1), d is an integer of preferably 5 to 200, more preferably 10 to 100, still more preferably 15 to 50, for example 25 to 35. In one embodiment, e is 1. In another embodiment, e is 0. In formula (f1), —(OC₃F₆)_{d}— is preferably a group represented by —(OCF₂CF₂CF₂)_{d}— or —(OCF(CF₃)CF₂)_{d}—, more preferably a group represented by —(OCF₂CF₂CF₂)_{d}—.

In the formula (f2), e and f are each independently an integer of preferably 5 to 200, more preferably 10 to 200, further preferably 10 to 100, and for example, an integer of 10 to 50, 10 to 30, or 20 to 30. c and d are each independently preferably 0 or 1. The sum of c, d, e, and f is preferably 5 or more, more preferably 10 or more, and for example, may be 15 or more, or 20 or more. For example, the sum of c, d, e, and f may be 15 or more and 100 or less, 15 or more and 60 or less, 15 or more and 50 or less, 20 or more and 60 or less, or 20 or more and 50 or less. In one embodiment, the group of the formula (f2) is preferably a group represented by —(OCF₂CF₂CF₂CF₂)_{c}—(OCF₂CF₂CF₂)_{d}—(OCF₂CF₂)ₑ—(OCF₂)_{f}—. In another embodiment, the group of the formula (f2) may be a group represented by —(OC₂F₄)ₑ—(OCF₂)_{f}—.

In the formula (f3), R⁶ is preferably OC₂F₄. In the formula (f3), R⁷ is preferably a group selected from OC₂F₄, OC₃F₆ and OC₄F₈, or a combination of two or three groups independently selected from these groups, more preferably a group selected from OC₃F₆ and OC₄F₈. Examples of the combination of two or three groups independently selected from OC₂F₄, OC₃F₆, and OC₄F₈ include, but are not limited to, —OC₂F₄OC₃F₆—, —OC₂F₄OC₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC₂F₄OC₃F₆—, —OC₂F₄OC₂F₄OC₄F₈—, —OC₂F₄OC₃F₆OC₂F₄—, —OC₂F₄OC₃F₆OC₃F₆—, —OC₂F₄OC₄F₈OC₂F₄—, —OC₃F₆OC₂F₄OC₂F₄—, —OC₃F₆OC₂F₄OC₃F₆—, —OC₃F₆OC₃F₆OC₂F₄—, and —OC₄F₈OC₂F₄OC₂F₄—. In the formula (f3), g is an integer of preferably 3 or more, more preferably 5 or more. g is preferably an integer of 50 or less. In the formula (f3), OC₂F₄, OC₃F₆, OC₄F₈, OC₅F₁₀ and OC₆F₁₂ may be linear or branched, and are preferably linear. In this embodiment, the formula (f3) is preferably —(OC₂F₄—OC₃F₆)_{g}— or —(OC₂F₄—OC₄F₈)_{g}—.

In the formula (f4), R⁶, R⁷, and g are the same as defined in the formula (f3), and have the same forms. R⁶′, R⁷′, and g′ are the same as R⁶, R⁷, and g defined in the formula (f3), and have the same forms. R^{r} is preferably

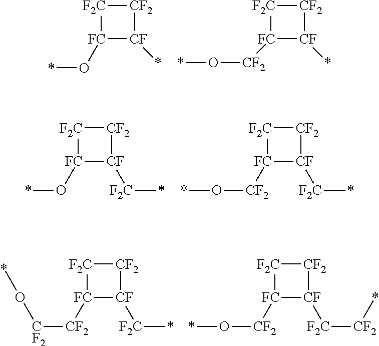

wherein * represents a binding position,
and more preferably

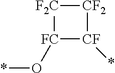

wherein * represents a binding position.

In the formula (f5), e is an integer of preferably 1 or more and 100 or less, and more preferably 5 or more and 100 or less. The sum of a, b, c, d, e, and f is preferably 5 or more, more preferably 10 or more, and for example, may be 10 or more and 100 or less.

In the formula (f6), f is an integer of preferably 1 or more and 100 or less, and more preferably 5 or more and 100 or less. The sum of a, b, c, d, e, and f is preferably 5 or more, more preferably 10 or more, and for example, may be 10 or more and 100 or less.

In one embodiment, R^{F} is a group represented by the formula (f1).

In one embodiment, R^{F} is a group represented by the formula (f2).

In one embodiment, R^{F} is a group represented by the formula (f3).

In one embodiment, R^{F} is a group represented by the formula (f4).

In one embodiment, R^{F} is a group represented by the formula (f5).

In one embodiment, R^{F} is a group represented by the formula (f6).

In R^{F}, the ratio of e to f (hereinafter, referred to as an “e/f ratio”) is 0.1 to 10, preferably 0.2 to 5, more preferably 0.2 to 2, still more preferably 0.2 to 1.5, and even more preferably 0.2 to 0.85.

In the fluoropolyether group-containing silane compound, the number average molecular weight of the R^{F} moiety is not limited, and is, for example, 500 to 30,000, preferably 1,500 to 30,000, more preferably 2,000 to 10,000. In the present description, the number average molecular weight of each of the R^{F1} and R^{F2} is defined as a value obtained by ¹⁹F-NMR measurement.

In another embodiment, the number average molecular weight of each of the R^{F1} and R^{F2} moieties may be 500 to 30,000, preferably 1,000 to 20,000, more preferably 2,000 to 15,000, and even more preferably 2,000 to 10,000, for example 3,000 to 6,000.

In another embodiment, the number average molecular weight of each of the R^{F1} and R^{F2} moieties may be 4, 000 to 30,000, preferably 5,000 to 10,000, and more preferably 6,000 to 10,000.

In the formula, X is a single bond or a divalent organic group.

In one embodiment, X is a single bond.

In another embodiment, X is a divalent organic group.

As used herein, the “divalent organic group” refers to a divalent group containing carbon. The divalent organic group is not limited, and may be a divalent hydrocarbon group or a derivative thereof. The derivative of the hydrocarbon group is a group having one or more N atoms, O atoms, S atoms, Si atoms, amide groups, sulfonyl groups, siloxane groups, carbonyl groups, carbonyloxy groups and the like at the end or in the molecular chain of the hydrocarbon group.

As used herein, the “divalent hydrocarbon group” means a group consisting of carbon and hydrogen, which is formed by removing two hydrogen atoms from a hydrocarbon. The hydrocarbon group is not limited, and examples thereof include a divalent C₁₋₂₀ hydrocarbon group such as an aliphatic hydrocarbon group and an aromatic hydrocarbon group. The “aliphatic hydrocarbon group” may be linear, branched or cyclic, and may be saturated or unsaturated. The hydrocarbon group may have one or more ring structures. The above “divalent hydrocarbon group” may be substituted with one or more substituents.

The substituent of the “hydrocarbon group”, as used herein, is not limited, and examples thereof include one or more groups selected from a halogen atom, and a C₁₋₆ alkyl group, a C₂₋₆ alkenyl group, a C₂₋₆ alkynyl group, a C₃₋₁₀ cycloalkyl group, a C₃₋₁₀ unsaturated cycloalkyl group, a 5 to 10-membered heterocyclyl group, a 5 to 10-membered unsaturated heterocyclyl group, a C₆₋₁₀ aryl group, and a 5 to 10-membered heteroaryl group each optionally substituted with one or more halogen atoms.

The divalent organic group is preferably a C₁₋₆ alkylene group, —(CH₂)_{z1}—O—(CH₂)_{z2}— (wherein z1 is an integer of 0 to 6, for example an integer of 1 to 6, and z2 is an integer of 0 to 6, for example an integer of 1 to 6), or —(CH₂)_{z3}-phenylene-(CH₂)_{z4}— (wherein z3 is an integer of 0 to 6, for example an integer of 1 to 6, z4 is an integer of 0 to 6, for example an integer of 1 to 6). The C₁₋₆ alkylene group may be linear or branched, and is preferably linear. These groups may be substituted with one or more substituents selected from, for example, a fluorine atom, a C₁₋₆ alkyl group, a C₂₋₆ alkenyl group, and a C₂₋₆ alkynyl group, and is preferably unsubstituted.

In the formula, R1 is a C₁₋₆ alkyl group.

The C₁₋₆ alkyl group may be linear or branched. In one embodiment, the C₁₋₆ alkyl group is linear. In another embodiment, the C₁₋₆ alkyl group is branched. The above C₁₋₆ alkyl group is preferably a C₁₋₄ alkyl group, more preferably a C₁₋₃ alkyl group, further preferably a methyl group or an ethyl group, and still more preferably a methyl group.

### Production of Fluoropolyether Group-Containing Carboxylic Acid

In the method of the present disclosure, a fluoropolyether group-containing carboxylic acid ester can be converted to a fluoropolyether group-containing carboxylic acid by using propionic acid in a shorter time and with a higher conversion rate than when other acids, such as formic acid, are used. Furthermore, by using propionic acid, adverse effects to equipment can be reduced compared to using an inorganic acid, such as hydrochloric acid, thereby preventing, for example, corrosion of reaction vessels.

Without being bound by theory, the fluoropolyether group-containing carboxylic acid ester is hydrolyzed in the method of the present disclosure.

### Embodiment 1

In Embodiment 1, the method of the present disclosure is performed as follows using a fluoropolyether group-containing carboxylic acid ester and propionic acid.

A predetermined amount of a fluoropolyether group-containing carboxylic acid ester and predetermined equivalents of propionic acid relative to the fluoropolyether group-containing carboxylic acid ester are added and mixed in a reaction container. The mixture is stirred at elevated temperature. After a predetermined time, the volatile components are distilled off under reduced pressure to give a fluoropolyether group-containing carboxylic acid.

In the present embodiment, propionic acid is added in one portion. By adding propionic acid in one portion, the process is simplified.

In the method of the present disclosure, the amount of propionic acid used may be preferably 2.0 equivalents or more, more preferably 2.8 equivalents or more, and for example, 5.0 equivalents or more, or 5.2 equivalents or more relative to the ester group of the fluoropolyether group-containing carboxylic acid ester. The amount of propionic acid used may be preferably 20 equivalents or less, more preferably 10 equivalents or less, and for example, 6.0 equivalents or less relative to the ester group of the fluoropolyether group-containing carboxylic acid ester. By setting the amount of propionic acid used in the above range, the reaction rate for the conversion of a fluoropolyether group-containing carboxylic acid ester to a fluoropolyether group-containing carboxylic acid is increased.

Herein, the number of the ester groups in the fluoropolyether group-containing carboxylic acid ester may be calculated from the weight of the fluoropolyether group-containing carboxylic acid ester and the measurement results of ¹⁹F-NMR.

The reaction temperature in the above reaction may be preferably 100° C. or more, more preferably 110° C. or more, and further preferably 130° C. or more. The upper limit of the reaction temperature is not limited as long as the compound is not decomposed at the temperature, and may be, for example, 180° C. or less, and preferably 150° C. or less.

The reaction time for the above reaction is preferably 20 hours or more, more preferably 30 hours or more, and may be, for example, 40 hours or more. The upper limit of the reaction time is not limited, and may be, for example, 100 hours or less.

### Embodiment 2

In Embodiment 2, the method of the present disclosure is performed as follows using a fluoropolyether group-containing carboxylic acid ester, propionic acid and water.

A predetermined amount of a fluoropolyether group-containing carboxylic acid ester, predetermined equivalents of propionic acid and water relative to the fluoropolyether group-containing carboxylic acid ester are added and mixed in a reaction container. The mixture is stirred at elevated temperature. After a predetermined time, the volatile components are distilled off under reduced pressure to give a fluoropolyether group-containing carboxylic acid.

In Embodiment 2, water is used in addition to Embodiment 1. By using water, the reaction rate for the conversion of a fluoropolyether group-containing carboxylic acid ester to a fluoropolyether group-containing carboxylic acid is increased. In the present embodiment, propionic acid and water are added in one portion. By adding propionic acid and water in one portion, the process is simplified.

In the present embodiment, the amount of water used may be preferably 10 equivalents or less, and more preferably 3 equivalents or less relative to the ester group of the fluoropolyether group-containing carboxylic acid ester. The amount of water used may be preferably 0.1 equivalent or more, more preferably 0.5 equivalents or more, and for example 1.0 equivalent or more, or 2.0 equivalents or more relative to the ester group of the fluoropolyether group-containing carboxylic acid ester. By setting the amount of water used in the above range, the reaction rate for the conversion of a fluoropolyether group-containing carboxylic acid ester to a fluoropolyether group-containing carboxylic acid is increased.

In the present embodiment, the amount of propionic acid used, reaction temperature, and reaction time may be the same as those in Embodiment 1.

### Embodiment 3

In Embodiment 3, the method of the present disclosure is performed as follows using a fluoropolyether group-containing carboxylic acid ester, propionic acid and water.

A predetermined amount of a fluoropolyether group-containing carboxylic acid ester, predetermined equivalents of propionic acid and water relative to the fluoropolyether group-containing carboxylic acid ester are added and mixed in a reaction container. The mixture is stirred at elevated temperature. After a predetermined time, preferably when the reaction approaches equilibrium, predetermined equivalents of propionic acid and water are added relative to the amount of unreacted ester groups, and the mixture is stirred at elevated temperature. The volatile components are distilled off under reduced pressure to give a fluoropolyether group-containing carboxylic acid.

In Embodiment 3, water is used in addition to Embodiment 1. By using water, the reaction rate for the conversion of a fluoropolyether group-containing carboxylic acid ester to a fluoropolyether group-containing carboxylic acid is increased. In the present embodiment, propionic acid and water are added in one portion. By adding propionic acid and water in one portion, the process is simplified.

By adding propionic acid and water in two portions, a high conversion rate can be achieved in a short time. In the present embodiment, propionic acid and water are added in two portions; however, they may be added in several portions. The number of additions is not limited, and may be, for example, 2 to 5, preferably 2 or 3. Furthermore, when water is not used, propionic acid may be added in several portions.

When propionic acid and water are added in several portions, the amount added may be the same as the equivalents in the first addition relative to unreacted ester groups of the fluoropolyether group-containing carboxylic acid ester at the time of addition. For example, when 5.0 equivalents of propionic acid and 2.5 equivalents of water are used relative to the ester group of the fluoropolyether group-containing carboxylic acid ester in the first addition, 5.0 equivalents of propionic acid and 2.5 equivalents of water are also used in the second and subsequent additions.

In the present embodiment, the amount of propionic acid and water used, reaction temperature, and reaction time may be the same as those in Embodiments 1 and 2. The amount used refers to the total amount for all additions.

The present disclosure includes the following embodiments.

[1] A method for producing a fluoropolyether group-containing carboxylic acid from a fluoropolyether group-containing carboxylic acid ester, comprising using propionic acid.
[2] The method according to [1], wherein the fluoropolyether group-containing carboxylic acid ester is a compound represented by the following formula (1) or (2):

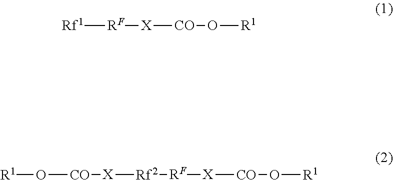

wherein Rf¹ is each independently at each occurrence a C₁₋₁₆ alkyl group optionally substituted with one or more fluorine atoms,
Rf² is a C₁₋₆ alkylene group optionally substituted with one or more fluorine atoms,
R^{F} is each independently at each occurrence a divalent fluoropolyether group,
X is a single bond or a divalent organic group, and
R¹ is a C₁₋₆ alkyl group.
   [3] The method according to [2], wherein R^{F} is each independently at each occurrence a group represented by the formula:

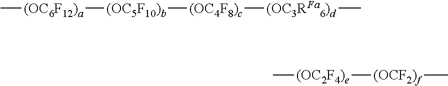

wherein R^{Fa} is each independently at each occurrence a hydrogen atom, a fluorine atom or a chlorine atom,
a, b, c, d, e, and f are each independently an integer of 0 to 200, the sum of a, b, c, d, e, and f is 1 or more, the occurrence order of the respective repeating units in parentheses provided with a, b, c, d, e or f is not limited in the formula, provided that if all R^{Fa}s are a hydrogen atom or a chlorine atom, at least one of a, b, c, e, and f is 1 or more.
   [4] The method according to [3], wherein R^{Fa} is a fluorine atom.
   [5] The method according to any one of [2] to [4], wherein R^{F} is each independently at each occurrence a group represented by the following formula (f1), (f2), (f3), (f4), (f5), or (f6):

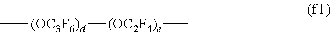

wherein d is an integer of 1 to 200 and e is 0 or 1,

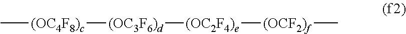

c and d are each independently an integer of 0 to 30;
e and f are each independently an integer of 1 to 200;
the sum of c, d, e, and f is an integer of 10 to 200; and
the occurrence order of the respective repeating units in parentheses provided with subscript c, d, e, or f is not limited in the formula,

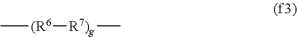

wherein R⁶ is OCF₂ or OC₂F₄;
R⁷ is a group selected from OC₂F₄, OC₃F₆, OC₄F₈, OC₅F₁₀ and OC₆F₁₂ or a combination of two or three groups selected from these groups; and
g is an integer of 2 to 100,

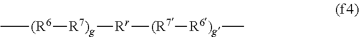

wherein R⁶ is OCF₂ or OC₂F₄,
R⁷ is a group selected from OC₂F₄, OC₃F₆, OC₄F₈, OC₅F₁₀ and OC₆F₁₂ or a combination of two or three groups independently selected from these groups,
R^{6′} is OCF₂ or OC₂F₄,
R^{7′} is a group selected from OC₂F₄, OC₃F₆, OC₄F₈, OC₅F₁₀ and OC₆F₁₂ or a combination of two or three groups independently selected from these groups,
g is an integer of 2 to 100,
g′ is an integer of 2 to 100, and
R^{r} is

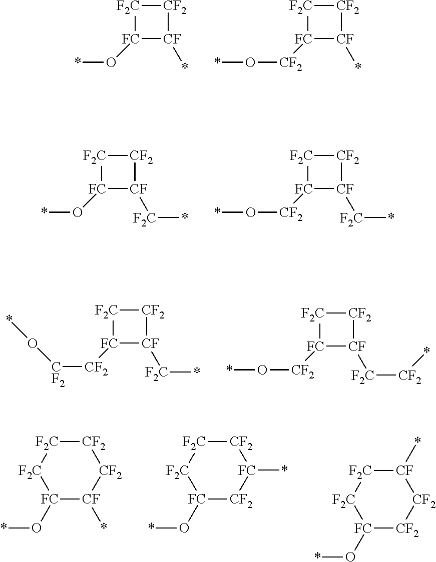

wherein * represents a binding position;

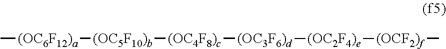

wherein e is an integer of 1 or more and 200 or less, a, b, c, d, and f are each independently an integer of 0 or more and 200 or less, and the occurrence order of the respective repeating units in parentheses provided with a, b, c, d, e, or f is not limited in the formula,

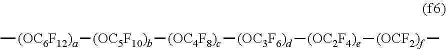

wherein f is an integer of 1 or more and 200 or less, a, b, c, d, and e are each independently an integer of 0 or more and 200 or less, and the occurrence order of the respective repeating units in parentheses provided with a, b, c, d, e, or f is not limited in the formula.
   [6] The method according to any one of [2] to [5], wherein R^{F} is each independently at each occurrence a group represented by the following formula (f2):

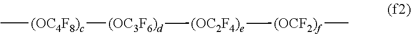

wherein c and d are each independently an integer of 0 to 30;
e and f are each independently an integer of 1 to 200;
the sum of c, d, e, and f is an integer of 10 to 200; and
the occurrence order of the respective repeating units in parentheses provided with subscript c, d, e, or f is not limited in the formula.
   [7] The method according to any one of [2] to [6], wherein R¹ is a methyl group.
   [8] The method according to any one of [2] to [7], wherein X is a single bond.
   [9] The method according to any one of [1] to [8], wherein the number of equivalents of propionic acid relative to the ester group of the fluoropolyether group-containing carboxylic acid ester is 2.0 equivalents or more.
   [10] The method according to any one of [1] to [9], wherein the number of equivalents of propionic acid relative to the ester group of the fluoropolyether group-containing carboxylic acid ester is 2.8 equivalents or more.
   [11] The method according to any one of [2] to [9], wherein
R1 is a methyl group,
X is a single bond, and
R^{F} is each independently at each occurrence a group represented by the following formula (f2):

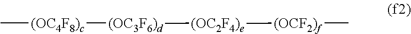

wherein c and d are each independently 0 or 1;
e and f are each independently an integer of 10 to 30;
the sum of c, d, e, and f is an integer of 20 to 50; and
the occurrence order of the respective repeating units in parentheses provided with subscript c, d, e, or f is not limited in the formula.
   [12] The method according to any one of [1] to [11], further comprising using water.
   [13] The method according to [12], wherein the number of equivalents of water relative to the ester group of the fluoropolyether group-containing carboxylic acid ester is 10 equivalents or less.
   [14] The method according to or [13], wherein the number of equivalents of water relative to the ester group of the fluoropolyether group-containing carboxylic acid ester is 3.0 equivalents or less.
   [15] The method according to any one of to [14], wherein the number of equivalents of water relative to the ester group of the fluoropolyether group-containing carboxylic acid ester is 0.5 to 3.0 equivalents.
   [16] The method according to any one of to [15], wherein the number of equivalents of propionic acid relative to the ester group of the fluoropolyether group-containing carboxylic acid ester is 2.0 equivalents or more, and the number of equivalents of water relative to the ester group of the fluoropolyether group-containing carboxylic acid ester is 10 equivalents or less.
   [17] The method according to any one of [1] to [16], comprising mixing the fluoropolyether group-containing carboxylic acid ester and propionic acid, and heating the mixture to 100° C. or more.
   [18] The method according to any one of [1] to [16], comprising mixing the fluoropolyether group-containing carboxylic acid ester, propionic acid, and water, and heating the mixture to 100° C. or more.

### Examples

Hereinafter the article according to the present disclosure will be described with reference to Examples, but the present disclosure is not limited to the following Examples. In Examples, the occurrence order of the repeating units forming fluoropolyether is not limited, and the chemical formulas shown below indicate average compositions.

### Example 1

A 100 mL four-neck flask equipped with a reflux condenser, thermometer, and stirrer was charged with perfluoropolyether-modified methyl ester body (1) (51.6 g) represented by an average composition of CH₃OCOCF₂O(CF₂CF₂O)₂₃(CF₂O)₂₂CF₂COOCH₃ (containing a small amount of a compound having a repeating unit of (CF₂CF₂CF₂O) and/or (CF₂CF₂CF₂CF₂O) in the mixture). Water (1.2 g, 2.6 equivalents relative to the ester group of the compound (1)) and propionic acid (9.3 g, 5.3 equivalents relative to the ester group of the compound (1)) were added thereto in two portions. Upon the second addition of the reagents, the flow of the cooling water in the reflux condenser was stopped, and the reaction solution was stirred at 110° C. to 130° C. for 32 hours. After determining the conversion rate to be 99% or more by ¹⁹F-NMR, volatile components were distilled off under reduced pressure to give 51.1 g of perfluoropolyether compound (2) having a terminal carboxyl group. The product obtained contained a small amount of water and propionic acid.

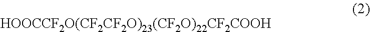

### Example 2

A 100 mL four-neck flask equipped with a reflux condenser, thermometer, and stirrer was charged with perfluoropolyether-modified methyl ester body (1) (50.3 g) represented by an average composition of CH₃OCOCF₂O(CF₂CF₂O)₂₃(CF₂O)₂₂CF₂COOCH₃ (containing a small amount of a compound having a repeating unit of (CF₂CF₂CF₂O) and/or (CF₂CF₂CF₂CF₂O) in the mixture). Water (1.4 g, 2.8 equivalents relative to the ester group of the compound (1)) and propionic acid (5.0 g, 2.8 equivalents relative to the ester group of the compound (1)) were added thereto in four portions. Upon the second addition of the reagents, the flow of the cooling water in the reflux condenser was stopped, and the reaction solution was stirred at 120° C. for 40 hours. After determining the conversion rate to be 99% or more by ¹⁹F-NMR, volatile components were distilled off under reduced pressure to give 49.5 g of perfluoropolyether compound (2) having a terminal carboxyl group. The product obtained contained a small amount of water and propionic acid.

### Example 3

A 100 mL four-neck flask equipped with a reflux condenser, thermometer, and stirrer was charged with perfluoropolyether-modified methyl ester body (1) (50.2 g) represented by an average composition of CH₃OCOCF₂O(CF₂CF₂O)₂₃(CF₂O)₂₂CF₂COOCH₃ (containing a small amount of a compound having a repeating unit of (CF₂CF₂CF₂O) and/or (CF₂CF₂CF₂CF₂O) in the mixture). Propionic acid (9.1 g, 5.2 equivalents relative to the ester group of the compound (1)) were added thereto in four portions. The reaction solution was stirred at 120° C. for 88 hours. After determining the conversion rate to be 99% or more by ¹⁹F-NMR, volatile components were distilled off under reduced pressure to give 49.4 g of perfluoropolyether compound (2) having a terminal carboxyl group. The product obtained contained a small amount of water and propionic acid.

### Example 4

A 100 mL four-neck flask equipped with a reflux condenser, thermometer, and stirrer was charged with perfluoropolyether-modified methyl ester body (1) (51.0 g) represented by an average composition of CH₃OCOCF₂O(CF₂CF₂O)₂₃(CF₂O)₂₂CF₂COOCH₃ (containing a small amount of a compound having a repeating unit of (CF₂CF₂CF₂O) and/or (CF₂CF₂CF₂CF₂O) in the mixture). Water (4.0 g, 9.5 equivalents relative to the ester group of the compound (1)) was added thereto in four portions, and propionic acid (8.9 g, 5.2 equivalents relative to the ester group of the compound (1)) were added thereto in six portions. Upon the fifth addition of propionic acid, the flow of the cooling water in the reflux condenser was stopped, and the reaction solution was stirred at 100° C. to 120° C. for 82 hours. After determining the conversion rate to be 99% or more by ¹⁹F-NMR, volatile components were distilled off under reduced pressure to give 50.2 g of perfluoropolyether compound (2) having a terminal carboxyl group. The product obtained contained a small amount of water and propionic acid.

### Comparative Example 1

A 100 mL four-neck flask equipped with a reflux condenser, thermometer, and stirrer was charged with perfluoropolyether-modified methyl ester body (1) (51.6 g) represented by an average composition of CH₃OCOCF₂O(CF₂CF₂O)₂₃(CF₂O)₂₂CF₂COOCH₃ (containing a small amount of a compound having a repeating unit of (CF₂CF₂CF₂O) and/or (CF₂CF₂CF₂CF₂O) in the mixture). Water (1.2 g, 2.6 equivalents relative to the ester group of the compound (1)) was added thereto in two portions. Upon the second addition, the flow of the cooling water in the reflux condenser was stopped, and the reaction solution was stirred at 110° C. to 130° C. for 280 hours. After determining the conversion rate to be 99% or more by ¹⁹F-NMR, volatile components were distilled off under reduced pressure to give 51.0 g of perfluoropolyether compound (2) having a terminal carboxyl group. The product obtained contained a small amount of water and propionic acid.

### Comparative Example 2

A 100 mL four-neck flask equipped with a reflux condenser, thermometer, and stirrer was charged with perfluoropolyether-modified methyl ester body (1) (51.6 g) represented by an average composition of CH₃OCOCF₂O(CF₂CF₂O)₂₃(CF₂O)₂₂CF₂COOCH₃ (containing a small amount of a compound having a repeating unit of (CF₂CF₂CF₂O) and/or (CF₂CF₂CF₂CF₂O) in the mixture). Water (1.2 g, 2.6 equivalents relative to the ester group of the compound (1)) and formic acid (5.8 g, 5.3 equivalents relative to the ester group of the compound (1)) were added thereto in two portions. Upon the second addition of the reagents, the flow of the cooling water in the reflux condenser was stopped, and the reaction solution was stirred at 110° C. to 130° C. for 100 hours. The conversion rate was determined by ¹⁹F-NMR to be 80%.

### Comparative Example 3

A 100 mL four-neck flask equipped with a reflux condenser, thermometer, and stirrer was charged with perfluoropolyether-modified methyl ester body (1) (50.3 g) represented by an average composition of CH₃OCOCF₂O(CF₂CF₂O)₂₃(CF₂O)₂₂CF₂COOCH₃ (containing a small amount of a compound having a repeating unit of (CF₂CF₂CF₂O) and/or (CF₂CF₂CF₂CF₂O) in the mixture). Water (1.4 g, 2.8 equivalents relative to the ester group of the compound (1)) and formic acid (3.1 g, 2.8 equivalents relative to the ester group of the compound (1)) were added thereto in four portions. Upon the second addition of the reagents, the flow of the cooling water in the reflux condenser was stopped, and the reaction solution was stirred at 120° C. for 100 hours. The conversion rate was determined by ¹⁹F-NMR to be 71%.

TABLE 1

| | | Amount of | Amount of | Reaction | Conversion |
|---|---|---|---|---|---|
| | | acid added | water added | time | rate |
| | Acid | (equivalents) | (equivalents) | (hours) | (%) |
| Example 1 | Propionic | 5.3 | 2.6 | 32 | ≥99 |
| | acid | | | | |
| Example 2 | Propionic | 2.8 | 2.8 | 40 | ≥99 |
| | acid | | | | |
| Example 3 | Propionic | 5.2 | 0 | 88 | ≥99 |
| | acid | | | | |
| Example 4 | Propionic | 5.2 | 9.5 | 82 | ≥99 |
| | acid | | | | |
| Comparative | None | 0 | 2.6 | 280 | ≥99 |
| Example 1 | | | | | |
| Comparative | Formic | 5.3 | 2.6 | 100 | 80 |
| Example 2 | acid | | | | |
| Comparative | Formic | 2.8 | 2.8 | 100 | 71 |
| Example 3 | acid | | | | |

### Industrial Applicability

The method of the present disclosure can be suitably used for the production of a fluoropolyether group-containing carboxylic acid.

1. A method for producing a fluoropolyether group-containing carboxylic acid from a fluoropolyether group-containing carboxylic acid ester, using propionic acid.

2. The method according to claim 1, wherein the fluoropolyether group-containing carboxylic acid ester is a compound represented by the following formula (1) or (2): 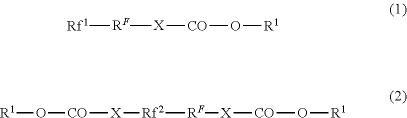
wherein Rf¹ is each independently at each occurrence a C₁₋₁₆ alkyl group optionally substituted with one or more fluorine atoms,
Rf² is a C₁₋₆ alkylene group optionally substituted with one or more fluorine atoms,
R^{F} is each independently at each occurrence a divalent fluoropolyether group,
X is a single bond or a divalent organic group, and
R¹ is a C₁₋₆ alkyl group.

3. The method according to claim 2, wherein
R^{F} is each independently at each occurrence a group represented by the formula: 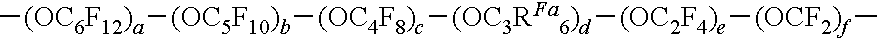
wherein R^{Fa} is each independently at each occurrence a hydrogen atom, a fluorine atom or a chlorine atom,
a, b, c, d, e, and f are each independently an integer of 0 to 200, the sum of a, b, c, d, e, and f is 1 or more, the occurrence order of the respective repeating units in parentheses provided with a, b, c, d, e or f is not limited in the formula, provided that if all R^{Fa}s are a hydrogen atom or a chlorine atom, at least one of a, b, c, e, and f is 1 or more.

4. The method according to claim 3, wherein R^{Fa} is a fluorine atom.

5. The method according to claim 2, wherein R^{F} is each independently at each occurrence a group represented by the following formula (f1), (f2), (f3), (f4), (f5), or (f6): 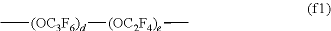
wherein d is an integer of 1 to 200 and e is 0 or 1, 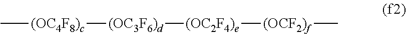
wherein c and d are each independently an integer of 0 to 30;
e and f are each independently an integer of 1 to 200;
the sum of c, d, e, and f is an integer of 10 to 200; and
the occurrence order of the respective repeating units in parentheses provided with subscript c, d, e, or f is not limited in the formula, 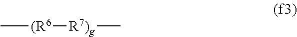
wherein R⁶ is OCF₂ or OC₂F₄;
R⁷ is a group selected from OC₂F₄, OC₃F₆, OC₄F₈, OC₅F₁₀ and OC₆F₁₂ or a combination of two or three groups selected from these groups; and
g is an integer of 2 to 100, 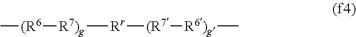
wherein R⁶ is OCF₂ or OC₂F₄,
R⁷ is a group selected from OC₂F₄, OC₃F₆, OC₄F₈, OC₅F₁₀ and OC₆F₁₂ or a combination of two or three groups independently selected from these groups,
R^{6′} is OCF₂ or OC₂F₄,
R^{7′} is a group selected from OC₂F₄, OC₃F₆, OC₄F₈, OC₅F₁₀ and OC₆F₁₂ or a combination of two or three groups independently selected from these groups,
g is an integer of 2 to 100,
g′ is an integer of 2 to 100, and
R^{r} is 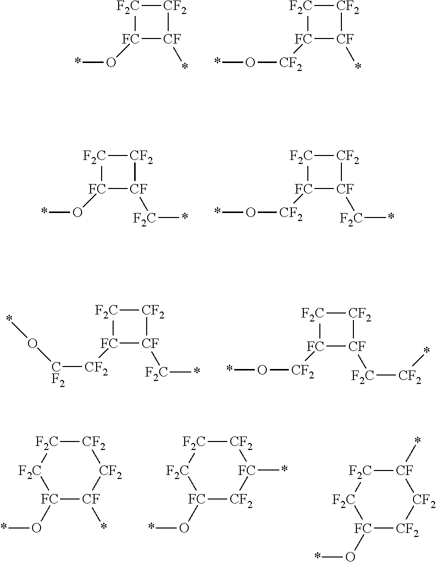
wherein * represents a binding position; 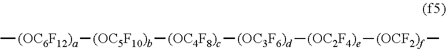
wherein e is an integer of 1 or more and 200 or less, a, b, c, d, and f are each independently an integer of 0 or more and 200 or less, and the occurrence order of the respective repeating units in parentheses provided with a, b, c, d, e, or f is not limited in the formula, 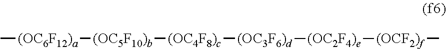
wherein f is an integer of 1 or more and 200 or less, a, b, c, d, and e are each independently an integer of 0 or more and 200 or less, and the occurrence order of the respective repeating units in parentheses provided with a, b, c, d, e, or f is not limited in the formula.

6. The method according to claim 2, wherein R^{F} is each independently at each occurrence a group represented by the following formula (f2): 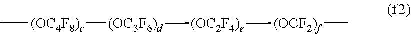
wherein c and d are each independently an integer of 0 to 30;
e and f are each independently an integer of 1 to 200;
the sum of c, d, e, and f is an integer of 10 to 200; and
the occurrence order of the respective repeating units in parentheses provided with subscript c, d, e, or f is not limited in the formula.

7. The method according to claim 2, wherein R¹ is a methyl group.

8. The method according to claim 2, wherein X is a single bond.

9. The method according to claim 1, wherein the number of equivalents of propionic acid relative to the ester group of the fluoropolyether group-containing carboxylic acid ester is 2.0 equivalents or more.

10. The method according to claim 1, wherein the number of equivalents of propionic acid relative to the ester group of the fluoropolyether group-containing carboxylic acid ester is 2.8 equivalents or more.

11. The method according to claim 2, wherein
R¹ is a methyl group,
X is a single bond, and
R^{F} is each independently at each occurrence a group represented by the following formula (f2): 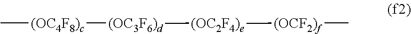
wherein c and d are each independently 0 or 1;
e and f are each independently an integer of 10 to 30;
the sum of c, d, e, and f is an integer of 20 to 50; and
the occurrence order of the respective repeating units in parentheses provided with subscript c, d, e, or f is not limited in the formula.

12. The method according to claim 1, further comprising using water.

13. The method according to claim 12, wherein the number of equivalents of water relative to the ester group of the fluoropolyether group-containing carboxylic acid ester is 10 equivalents or less.

14. The method according to claim 12, wherein the number of equivalents of water relative to the ester group of the fluoropolyether group-containing carboxylic acid ester is 3.0 equivalents or less.

15. The method according to claim 12, wherein the number of equivalents of water relative to the ester group of the fluoropolyether group-containing carboxylic acid ester is 0.5 to 3.0 equivalents.

16. The method according to claim 12, wherein the number of equivalents of propionic acid relative to the ester group of the fluoropolyether group-containing carboxylic acid ester is 2.0 equivalents or more, and the number of equivalents of water relative to the ester group of the fluoropolyether group-containing carboxylic acid ester is 10 equivalents or less.

17. The method according to claim 1, comprising mixing the fluoropolyether group-containing carboxylic acid ester and propionic acid, and heating the mixture to 100° C. or more.

18. The method according to claim 1, comprising mixing the fluoropolyether group-containing carboxylic acid ester, propionic acid, and water, and heating the mixture to 100° C. or more.
